(19) United States
(12) Patent Application Publication
(10) Pub. No.: US 2023/0172097 A1
(43) Pub. Date: Jun. 8, 2023

(54) METHOD AND APPARATUS FOR USE IN ESTABLISHING OR RE-ESTABLISHING PLANT LIFE IN A LAND AREA

(71) Applicant: Botanic Gardens and Parks Authority, Kings Park (AU)

(72) Inventors: Todd Erland ERICKSON, Kings Park (AU); Andrew Louis Guzzomi, Crawley (AU); Monte Ian Masarei, Crawley (AU); David John Merritt, Kings Park (AU)

(73) Assignee: Botanic Gardens and Parks Authority, Kings Park (AU)

(21) Appl. No.: 18/072,868

(22) Filed: Dec. 1, 2022

(30) Foreign Application Priority Data
Dec. 3, 2021 (AU) 2021903931

(51) Int. Cl. A01C 23/00; A01C 23/04; A01C 21/00

(52) U.S. Cl. CPC A01C 23/007; A01C 23/042; A01C 21/00

(57) ABSTRACT

An apparatus for use in establishing or re-establishing plant growth over a land area. The apparatus includes a supply of a growing medium and an arrangement including at least one delivery outlet for delivering the growing medium at spaced intervals from a height onto a soil surface of the land area. The growing medium contains seeds or is delivered in tandem with and on top of seeds deposited on the soil surface or deposited onto or adjacent to seeds or seedlings already deposited on the soil surface.

This application claims priority under 35 U.S.C. § 119(a) to Australian Patent Application No. 2021903931, filed on Dec. 3, 2021, the entire contents of each of which are incorporated herein by reference.

### BACKGROUND OF THE INVENTION

### Field of The Invention

The present invention relates to a method and/or apparatus for use in establishing or re-establishing plant life in a land area.

The present invention is particularly, though not solely, applicable to a method and apparatus for use in creating and/or dispensing a growing medium such as for depositing onto seeds or along with seeds which may be contained within the growing medium.

It will be appreciated that these are non-limiting examples and the present invention is applicable to other suitable areas and soils requiring rehabilitation or re-establishment of plant life.

### Description of the Related Art

Maintenance and restoration of natural ecosystems is of global importance. Climate change and land disturbance, such as through mining and infrastructure projects, can degrade or make establishment of plant regrowth slow or impossible. Restoration of dryland areas and/or disturbed soils around industrial and mine sites is particularly challenging, with re-establishment of vegetation historically having low success rates.

For example, mining disturbs large areas of natural ecosystems each year. Mandates are often in place to ensure restoration of degraded sites to re-establish the ecosystem and conserve biodiversity, particularly once operations cease, such as at the end of life of a mine site.

Despite the need, large scale restoration techniques often fail. When trying the re-establish native plant growth, particular conditions are needed for successful seed germination and subsequent seedling emergence and establishment. Germinating native seeds and maxi-rising establishment to re-instate plant communities on degraded sites necessitates understanding of complex native seed biology, as well as plant-soil-environment interactions in varying weather conditions and in a changing climate.

Suitably engineered and employed tools can significantly help to manipulate the abiotic and biotic conditions required to facilitate plant establishment and ecosystem restoration, and thereby improve success rates. Economic benefits flow from efficient and effective tools and equipment that aid successful plant re-establishment.

Challenges occur through the inability to establish suitable initial conditions to promote germination of seeds, emergence of seedlings or growth of cultivated plant stock, particularly in dryland soils, degraded soils and/or sloping terrain. For example, sloped terrains in harsh soil conditions (such as rocky soils of varying morphological structures, particularly where water run off or hydrophobic solids are present) creates significant limitations for known sowing/planting equipment to seed or establish cultivated plant stock.

Revegetation is presently carried out either by the direct return of seeds to a site or through the time consuming and expensive process of planting nursery cultivated seedlings. Seeds may be returned to a site either by respreading original topsoil which naturally contains seeds, or by directly seeding the site by hand or mechanically. Cultivated plants can also either be hand planted or mechanically returned.

However, due to the diverse nature of reinstating an ecosystem containing a variety of plant species with varying requirements, restoration often requires a combination of multiple seeding techniques. As an example, lack of rainfall and high evapotranspiration rates in dryland conditions means dryland species have developed diverse seed dormancy and recruitment strategies to cope with variable and sporadic moisture availability.

It has been realised that accommodating such biological mechanisms when considering planting or seeding as part of restoration, particularly for manmade (e.g. mine site restoration in parts of Australia) or natural dryland areas, can lead to better outcomes for germination, emergence, and long-term plant establishment.

Known restoration techniques include deep ripping of the soil to create deep furrows. For example, waste soil and rock waste dumps from mining operations are typically re-profiled to an angle of 15° with some slopes reaching up to 18° or 20°. Deep ripping may be carried out to depths of between 100 mm and 800 mm. Where slopes are thought to be prone to slope failure caused by water runoff, the sawtooth topography created by deep ripping is thought to help retain water infiltration in the furrows (‘water harvesting’) and therefore promote germination, establishment and plant growth. However, poor plant establishment from seeded species indicates that deep ripping is not particularly effective,

Known seeding techniques include mechanical broadcasting. For instance, in some mining environments seeding can be conducted with air seeding units attached above the deep ripping tines of a bulldozer. These units meter seeds into a delivery tube, and seeding rates are adjusted by increasing or decreasing the size of an orifice delivering the seeds to the deep ripped furrows, In some uses, seeds from species with different morphological properties or ecological function are separated in different compartments so that they can be metered at differing rates. A fan blows the seeds out of the seeder at a required metered rate.

A limitation to these air seeding arrangements is that they are not coupled with any soil incorporation mechanism and exist solely to meter and distribute seed. Without any additional soil incorporation stage, seeds remaining on the surface of the deeply ripped soil surface are prone to germination and emergence failure. Surface sown seeds are particularly prone to desiccation in regions where air temperatures can reach 50° C. and soil surface temperatures as high as 75° C.

Sowing seeds by aerial broadcasting is popular due to the ability to distribute seeds at a low cost quickly over large areas with the aid of simple machinery. However, winds can blow surface sown seeds off the target restoration sites. Predation is also an issue with various species of insects, rodents, and birds eating or removing seeds broadcast on restoration sites.

Rainfall is sporadic and varied in dryland areas. Without irrigation, seeds must persist on restoration sites for long periods, years in some cases. Ensuring the long-term viability of seeds by incorporating them into the soil surface of restoration sites is therefore extremely important. Deep ripping, however, makes burial of seeds to a suitable level (approximately <20 mm for most native seeds) difficult or impractical for plant recruitment near the soil surface.

Large, heavy industrial vehicles are typically used for deep ripping and seeding during restoration of mine sites due to their ready availability, ruggedness and suitability for the environment, plus the need and availability for trained drivers for such vehicles. Such large, heavy industrial vehicles e.g. dozers, can cope with the uneven terrain and can ride over rocks encountered during deep ripping. However, such large tracked vehicles tend to pitch fore and aft over large rocks, causing the ripper box mounted seeding equipment to pitch with, the vehicle, thereby making, seeding difficult or at least inaccurate, particularly for seeds that optimally require a few 10s of millimetres seeding depth, adding to the low regrowth success rate.

Alternatively, traditional agricultural precision seeding machinery (such as drill seeding) places seeds at a particular depth within the soil surface and/or with seeds at a particular spacing on the soil surface. Precision seeding can more accurately deliver seeds into soil conditions conducive to germination, emergence, and establishment, increasing overall seed use efficiency. Precision seeding ensures seeds are covered and embedded in the soil surface, increasing seed-soil contact and protecting seeds from predation. Placing seeds in optimal micro-sites can lead to far higher germination percentages than broadcasting seeds on the soil surface and, therefore, lead to a lower cost per established plant.

Traditional seeding machinery and planters, rely on the movement of soil (the growing medium) to open a furrow into which seeds are placed before soil is again moved to cover the seed. This relies on heavy soil engaging tools (e.g. ploughs, tines, etc.) to withstand the forces required to move the growing medium and results in large pieces of equipment (which need themselves to be massive and provide a dot of traction), making the precision planting of seeds on a millimetre-scale very difficult.

Rocky soils and complex topographies such as steep slopes exacerbate the problem of achieving millimetre precision with these devices.

Seeds of wild plant species often possess physical and morphological traits that impede controlled and reliable delivery, even by known precision seeding machinery designed for horticulture and cropping. Seeds of most grasses are contained within complex floret structures that have dense hairs and possess protruding appendages (e.g. awns or lobes), limiting or precluding their flow through seeder tubing. For many such native species, the only option is to remove the seeds from their florets or remove the obstructing appendages from the florets before seeding to increase seed flow, adding cost and time to the process due to the logistical challenges of doing so at large scales and high volumes.

Another challenge associated with the use of conventional direct seeding machinery is the limited capacity to sow seeds in complex, heterogeneous topographies. Such topography is common in the mining sector where landforms can be rocky and graded to slopes of 15° or more.

Effective direct seeding or planting using known techniques and equipment has limitations arising from unpredictable precipitation patterns. Competition from weeds, predation and low germination rates are also common limitations to successful plant establishment. Mechanical limitations to effective direct seeding or planting include inability to effectively operate seeding or planting machinery over complex terrain, limits to seed/plant depth placement accuracy and precision and the inability to sow/plant over complex terrain and difficult soils.

It is preferred that seeds or cultivated plants can be placed in the soil surface at a depth that does not exceed that at which seedlings can emerge or establish in the soil. However, current machinery designs are not well suited to sowing or planting, particularly many native seeds having specific growing condition requirements, in more complex environments. Aside from depth control, spatial seeding/planting control is also a limitation in known equipment e.g. broadcast seeding creates random spacing, and precision seeding is useful for depth control but cannot ensure suitable spatial control for particular environments, such as for Australian native plants in poor quality soils with low rainfall, requiring managed spacing to reduce competition.

Seeding mechanisms that are used in agriculture are often designed to sow seeds much deeper than is required by native seeds, which is reflected by the difference in distribution of seed mass between native and agricultural seeds.

Native seeds, particularly Australian native seeds e.g. Triodia pungens (T. pungens), on average have much smaller seeds than those of typical agricultural crops such as wheat. Consequently, particularly with regard to such native seeds, current seeding technologies need to be adapted or new seeding solutions need to be developed to improve accuracy of seed placement at the optimal location within the soil surface to increase the probability of seed germination and emergence outcomes.

Although modern agricultural seeding devices suit agricultural seeds well, seeding depth variation is likely too high for smaller native species, such as, though not limited to, the Pilbara region of Australia. Compounding the issue rocky soil surfaces may, in effect, reduce the maximum emergence depths of seeds sown in such a surface, increasing the need for better depth precision.

Seeding or planting on the extremely harsh rocky, skeletal soil, which can be found, for example, on many mine rehabilitation, or restoration sites, can lead to the mechanical failure of the components (particularly soil agitation parts) of agricultural seeding devices. Since the rocks and gravel are desired in the soil surface to provide niches where water and seed can concentrate, and to provide landform stability, rehabilitation or restoration sites cannot be cleared of rocks to more easily plant as is the case in agriculture.

Topsoil or mining waste growth media can be deficient in nutrients and moisture for establishing germination and/or plant growth. This is particularly a common constraint to mine site restoration. Un-amended mine waste materials create a particularly challenging medium for establishing plant growth.

It has been realised that it is preferable to ensure that seeds or cultivated plants establish in topsoil with reduced, risk of being planted below a rock and in a way that makes much more efficient use of the limited presence or available stockpiles of topsoil.

Extruded seed pellets made from soil, mineral products and other compounds are starting to be developed and adopted for restoration programs. However, these pellets are premade off-site, and the extrusion process induces compaction in the pellet presenting friability issues once the pellets are distributed and risks damage to the seeds.

With the aforementioned in mind, it has been realised that it can be desirable to provide apparatus which ameliorates imperfect or poor initial growing conditions for seeds and/or plants to establish or re-establish plant life in an area of land or at least provide an alternative to known seeding or planting machines.

It has also been realised that it is desirable to provide apparatus to create or dispense a growing medium for use in establishing or re-establishing plant growth in an area. Such apparatus may provide onsite manufacture of growing medium, or temporary storage of such a growing medium prior to dispensing, in one or more forms, such as a slurry, pats and/or pellets.

### SUMMARY OF THE INVENTION

An aspect of the present invention provides an apparatus and/or method for providing a growing medium for use in promoting or supporting germination of seeds and emergence of seedlings and/or growth or establishment of plants, in a land area. The growing medium may be produced as a slurry or in a dried/semi-dried form (such as a loose flowable dry material, powder, pats or pellets).

One or more embodiments includes an apparatus for use in establishing or re-establishing plant growth over a land area, the apparatus including a supply of a growing medium and an arrangement including at least one delivery outlet for delivering the growing medium at spaced intervals from a height onto a soil surface of the land area, the growing medium contains seeds or is delivered in tandem with and on top of seeds deposited on the soil surface or deposited onto or adjacent to seeds or seedlings already deposited on the soil surface.

The growing medium may be pre-produced for later use. For example, a vehicle or static assembly may be provided that supports a transportable (e.g. mobile) growing medium production arrangement.

Embodiments may deliver seeds contained within or distributed separately from, optionally in tandem and metered with, a growing medium.

Embodiments can be capable of distributing water and a beneficial growing medium to seeds/plants after they have been distributed to improve growth.

One or more embodiments may include an apparatus and/or method including an arrangement configured for depositing seeds and/or the growing medium onto a soil surface.

The growing medium may include one or more plant beneficial compounds (such as germination stimulants related to fire, anti-stress agents), inorganic compounds and/or organic compounds (e.g. soil microbiota), such as for restoration of disturbed soils e.g. dryland areas, open-cut mine sites, strip mine sites or disturbed agricultural land, undergoing restoration.

One or more embodiments may include a supply of a fluid (e.g. liquid) growing medium, such as a slurry. The apparatus may include a reservoir for containing the liquid or semi-liquid growing medium, such as the slurry.

The growing medium may include a slurry of soil or other solids/particulate material and a liquid, such as water. One or more nutrients, elements, and/or beneficial compounds may be provided with the growing medium, such as e.g. nitrogen, potassium, phosphorous, anti-stress agents, germination stimulants/promoters.

The growing medium may be provided to at least one delivery outlet for release of the growing medium onto the soil surface. At least one conduit, such as one or more pipes or tubes may connect the reservoir or supply to the at least one delivery outlet.

The at least one delivery outlet may be provided at a desired height above the soil surface. The height may be selected based on one or more, or a combination, of plant species and seed type, travel speed/velocity, pumping speed, viscosity of the growing medium, ambient air temperature and/or ambient humidity, prevailing or predicted weather conditions (e.g. impending rain, expected dry, windy conditions).

Moisture content of the growing medium may be controlled to be within a desired range or at a desired level. Viscosity of the growing medium, such as ‘wetness’ of a slurry type growing medium, may be controlled or adapted to suit the soil type final desired shape, thickness, and contact of the growing medium with the restoration surface, weather conditions, topography etc.

Embodiments may include delivering the growing medium as a slurry, pats, pellets or flowable material (e.g. a powder or granular material).

The growing medium may include/incorporate seeds. Alternatively, the growing medium may be deposited onto one or more seeds or onto or at the base of one or more plants, and/or the seeds may be received into the growing medium after depositing the growing medium onto the ground.

The growing medium may include water or other liquid nutrient for plant growth. The growing medium may have water/liquid nutrient incorporated therein as a premixed slurry/liquid or mixed in a continuous delivery process e.g. immediately prior to depositing the growing medium as a liquid/slurry onto the ground/soil. Alternatively, the growing medium may be deposited and the water/liquid nutrient added thereafter to form a liquid/slurry form of the growing medium.

The growing medium (e.g. a slurry) mixture may be delivered through the at least one delivery outlet. Such delivery may be by extrusion through the respective delivery outlet.

Embodiments may also include delivering the seeds onto the soil surface before covering seeds by depositing, the slurry (growing medium) on top of the seeds.

One or more embodiments may include at least one pump, such as at least one peristaltic pump, for delivery of the medium from the supply, such as the reservoir. The supply may be from a continuous supply, such as provided by a continuous mixing process, or from a reservoir.

For example, a reservoir of the growing medium may be provided on-board a vehicle associated with the at least one delivery outlet (such as a vehicle or vehicle and trailer combination). The reservoir may contain a pre-mix of solid material (such as topsoil) and liquid (such as water) content. A continuous supply may be provided by equipment mixing solid material and liquid to create a slurry. For example, a supply of solid material and a supply of liquid may be post-mixed for rapid delivery in situ.

When delivered (e.g. dropped) from a height, the growing medium as a slurry may create a ‘pat’ (akin to a ‘cow pat’), preferably of expected or predefined thickness (thereby helping to manage/control seeding/planting depth) on the surface of the soil surface.

Delivery of the growing medium from a height onto the surface of the soil surface may be intermittent. For example, as the at least one delivery outlet is moving, delivery of the growing medium may be intermittent such that the pats are created spaced on the surface of the soil The spacing may be regular or irregular.

Delivery of the growing medium may be controlled in association with one, two or three translational degrees of freedom and one, two or three rotational degrees of freedom of the at least one delivery outlet.

Delivery of the growing medium, onto the surface of the soil may be synchronised to forward and/or lateral motion of the at least one delivery outlet.

Position of the at least one delivery outlet may be controlled by at least one position mechanism that moves the at least one delivery outlet. The at least one position mechanism may include one or more delivery outlets.

The position mechanism may include at least one traverser enabling lateral motion of the at least one delivery outlet relative to a forward direction of travel of the at least one delivery outlet. For example, the at least one traverser may move the at least one delivery outlet perpendicular to the direction of travel which allows the pats to be deposited anywhere within lateral width limits of the respective traverser.

The at least one traverser may include a slider mechanism (such as including a slide head driven by a motor and/or belt drive). A slide head may be mounted on at least one slide bar allowing motion of the slider in either direction along a longitudinal extent of the slide bar. Alternatively, a respective head may be driven on a toothed rack, which may be by motor and/or belt drive.

Traversing the at least one delivery outlet forward over the soil, surface provides two translational degrees of freedom (e.g. the first being the aforementioned lateral motion) allowing the growing medium to be placed in any location over the soil surface.

Height control/selection of the at least one delivery outlet provides a third degree of freedom. Furthermore, controlling viscosity of the growing medium and the delivery height provides superior control of pat thickness, width and/or ratio of the two after delivery (pat ‘splat’ thickness and/or width), fulfilling a preferment to control seed/plant/pat spacing. This spatial control allows for more authentic ecosystem designs to be seeded/planted since the development of more complex vegetation patterning can be facilitated. Embodiments of the present invention allow for seeds to be deposited onto more authentic micro-topographies since the ‘pats’ are deposited onto the soil or substrate structures.

Embodiments of the present invention do not require mechanical contact with the soil surface to satisfy a need for precision depth control. This may reduce seeding depth variation that may otherwise result from vehicle dynamics and vibration that occur during travel.

The delivery/deposition of a wet slurry (e.g. extruded by pump pressure) can double as a mobile “pellet like” production arrangement if dried pellets are necessary, reducing the need to freight topsoil off site to a pellet production area before freighting pellets back to site to be distributed.

Delivery/deposition rate may be metered by varying the seed density within the growing medium. Embodiments may therefore be independent of an additional seed metering mechanism and decouples the delivery/deposition process from air-seeders and bulldozers typically used land in restoration projects.

A slurry extrusion containing seeds can facilitate plant seedling emergence and establishment, with reduced risk of damage to the seeds during seeding because of the delivery within the slurry, for example, Triodia seeds and/or other species.

The growing medium may include pure topsoil or a waste/topsoil blend, preferably sieved to a maximum 5 mm particle size. The growing medium may be treated with one or more soil amendments. Soil amendments may include organic, components (such as T. pungens leaf material) or inorganic components such as liquid fertilisers or herbicides.

The growing medium may include microbes beneficial to the seeds plants. Delivery of the slurry may include the growing material incorporating the beneficial microbes or the microbes may be inoculated into the growing material during delivery or after delivery to the soil surface.

The growing material containing the microbes may beneficially inoculate the soil surface and/or waste material forming part of the growing medium with the beneficial microbes.

The delivered deposited slurry pats may be between 2 mm and 56 mm thick on average, which may preferably be determined by the plant species/species mix and seed type. For Triodia for example, preferably between 6 mm and 10 mm thick on average, and more preferably between 7.5 mm and 9 mm thick on average.

In keeping with one or more embodiments of the present invention, seeds are not sown or planted into an existing soil surface; rather seeds and a growing medium are deposited onto a soil surface, or seeds are deposited and subsequently the growing medium can be deposited onto the seeds.

The soil surface may be a natural soil surface or a created soil surface, such as topsoil brought in from a stockpile, or mine waste material.

The seeds may be provided along with the growing medium, such as including a correct particle size for the particular seed/plant type(s), placed on top of the existing soil surface.

The particle size may be of a selected size or size range, such as 1 mm to 5 mm, preferably up to 2 mm or <2mm. The growing medium may include sieved particles for particle size consistency, such as sieved to <5 mm.

The growing medium can be made up of varying materials, such as sand, silt, clay fractions and/or beneficial amendments/enhancements/additives (such as soil microbiota, stress agents, stimulants), which may come from different origins that are tailored for the pellet formulation and species.

The growing medium may be consistent in mix and make-up with the targeted soil environment of the seeding site.

The apparatus may be vehicle mounted or may be coupled to a vehicle, may be self-powered, or may include a trailer for towing.

A further aspect of the present invention includes a method for use in establishing or re-establishing plant growth over a land area, the method including depositing a growing medium onto a ground surface.

The growing medium may be provided as a slurry (optionally containing plant seeds). The plant seeds may first be deposited on the ground surface (such as into a hole or recess or other soil surface profile).

The slurry may be provided as a mix including soil and water. The slurry may be provided including a proportion of waste material.

Delivering the growing medium may be from a reservoir, such as a tank or container.

Delivery may include pumping the growing medium by use of at least one pump to the at least one delivery outlet via at least one conduit.

Depositing the growing medium and the seeds may be from a height onto the soil surface. The at least one delivery outlet may be provided at a height above the soil surface based on one or more of viscosity of the growing medium, ambient air temperature and/or ambient humidity, prevailing or predicted weather conditions.

Lateral position of the at least one delivery outlet may be controlled by a position mechanism. Controlling the lateral motion of the at least one delivery outlet may be provided relative to a forward direction of travel the at east on delivery outlet.

Embodiments may include metering delivery/deposition rate and/or volume of the growing medium and the seeds. Metering may include metering density of the seeds within the growing medium or the growing medium itself.

Embodiments may include providing one or more nutrients with/within the growing medium.

The growing medium may form at least one pat on contact with the soil surface. Delivery/depositing of the growing medium from a height onto the surface of the soil may be space/intermittent. When the at least one delivery outlet is moving, delivery of the growing medium may be intermittent such that said pats are created spaced on the surface of the soil.

Embodiments include delivery of the growing medium controlled in association with one, two or three degrees of freedom of motion of the at least one delivery outlet. Delivery of the growing medium onto the surface of the soil may be synchronised to forward and/or lateral motion of the at least one delivery outlet.

Embodiments include providing the growing medium including topsoil or a waste and topsoil blend. Providing the growing medium may include providing microbes in the growing medium beneficial to the seeds/plants.

Delivered/deposited said slurry pats may be between 2 mm and 50 mm thick on average, preferably between 6 mm and 10 mm thick on average, and more preferably between 7.5 mm and 9 mm thick on average.

Delivery/depositing of the slurry containing seeds may be guided and/or controlled via external communication or predetermined guidance program.

Embodiments include mixing and/or agitating the slurry in a storage container prior to delivery/depositing. Consistency of the slurry may be adjusted/controlled or set prior to delivery/depositing.

Vertical position of the at least one delivery outlet may be controlled or et for delivering the slurry by height control means to control morphology of the resulting slurry deposition.

Embodiments may include limiting at least one position of the at least one delivery outlet by at least one limiting device, such as electronic limit switches. Embodiments include providing multiple said delivery outlets spaced laterally with respect, to one another.

Embodiments include providing the growing medium with soil amendment and germination/emergence enhancing products.

Embodiments may include conducting the delivering/depositing from a vehicle for conveying the apparatus or part thereof, or for use in depositing the growing medium and seeds, may include a dozer (e.g. a bulldozer), tractor or other industrial or commercial vehicle, or be a towed vehicle, such as a trailer, or may be a tray back vehicle or dedicated vehicle.

Another aspect of the present invention provides a method of seeding includes travelling a vehicle over terrain, depositing a growing medium as a slurry containing seeds onto a soil surface (such as into a channel, furrow, recess or hole in the soil).

Embodiments of the present invention enable a unique approach to seeding that is in contrast to the traditional agricultural approach where seeds are sown “into” the existing soil surface by mechanically opening and placing seeds into a furrow which is then mechanically closed by a closing device (e.g. press wheel).

One or more embodiments of the present invention allows rocky or uneven ground to be left in place whilst the seeds are delivered in a growing medium as a slurry, preferably the growing medium is tailored to provide particle size and/or nutrients directed towards ideal growing conditions for the seeds therein.

Soil engaging tools may condition/manipulate/agitate the soil before delivery of the seeds and/or growing medium.

Movement of the at least one delivery outlet may be provided by a drive means, such as including a motor e.g. at least one stepper or servo motor, to provide movement lateral to the direction of forward motion to enable a soil surface to be ‘sown’/‘plant’. Motion (forward and/or laterally may be guided e.g. via GPS and/or mapping of an area to be covered across a geographical region.

Delivery/depositing of pats of the growing medium may be by automated/self-guiding terrestrial or aerial vehicle allowing production in situ and high payloads. The vehicle may include an unmanned robotic vehicle.

The apparatus or method may be for use in seeding via the distribution of growing medium, such as including a topsoil, as a slurry.

The at least one pump may include an auger type pump (e.g. a screw type auger drive for delivering the slurry).

Preferably the seeds are deposited onto the soil surface embedded in the slurry.

The apparatus may be mounted to a vehicle, may be self-powered, or provided on or as a trailer for towing.

The slurry may be mixed or agitated via at least one agitation/mixing device, such as, mixing blades, stirrers, auger or vibration.

The apparatus may include a water supply, wherein moisture may be provided/added (such as from a water reservoir/supply/tank) to control the slurry consistency.

At least one slurry pump, water pump and agitation/mixing device may be powered by external means, such as via tractor PTO, or internal means, such as via electricity stored or generated on board or hydraulic fluid flow.

The at least one growing medium delivery outlet may be positionable/moved vertically to control the morphology, i.e. height, of the resulting slurry deposition.

The at least one delivery outlet may be provided as multiple said delivery outlets for the slurry spaced laterally with respect to one another enabling the positioning of the slurry across a soil surface.

Preferably slurry delivery/deposition is driven via rotary motion, such as via DC stepper motors, servo motors, geared hydraulic motors, coupled to the driving/trailing wheels. The rotary motion may be converted to linear motion via means such as belt drive, slider-crank mechanism.

Position or aim of the at least one delivery outlet may be limited by at least one limiting device, such as one or more electronic or mechanical limit switches.

A conduit, such as a hose or tube, may be provided coupled to the at least one delivery outlet, by at least one rotary coupling or bearing so that twisting motion from the conduit or hose is not transferred to the at least one delivery outlet.

The at least one delivery outlet may include multiple said delivery outlets spaced laterally with respect to one another (e.g. across the vehicle), with or without lateral overlap, to increase the footprint of slurry deposition.

The slurry/growing medium may include one or more soil amendment and germination/emergence enhancing products, such as added to the growing medium from an on-board or external tank or hopper. The seeds may be added to the slurry mixture via the on-board or external hopper.

A metering arrangement may be provided so that seeds are metered, to the correct seed/soil ratio via seed metering device, such as fluted roller, vacuum meter etc.

It will be appreciated that embodiments of the present invention provide for seed burial (i.e. seed in a growing medium) provided on the surface of the ground without requiring, or optionally allowing for, creation of a hole or channel in the soil prior to seeding. Embodiments enable seeding with limited depth of topsoil or where the topsoil is rocky.

Production of the growing medium as a slurry, with optional seeds included in the slurry before depositing, can be carried out in situ at the site to be seeded, or can be premixed for subsequent delivery.

Preferably embodiments include 2 or more translational degrees of freedom:
Forward travel direction(s),
lateral positioning of the delivery outlet(s) relative to the vehicle
optionally, height of the delivery outlet(s) above soil surface can be controlled/adjusted
rate and/or periodicity of pat or pellet delivery can optionally be controlled, more preferably coupled to rate and/or periodicity of seed delivery.

Seeding or planting of the area of terrain can be mapped before seeding/planting and/or after seeding/planting. For example, the vehicle may be guided over the terrain and/or seeding/planting carried out relative to geographical/spatial coordinates, such, as by GPS guidance.

The vehicle may be a remotely controlled or remotely guided robotic vehicle, preferably unmanned.

Controlled ‘depth’ and/or pat thickness (e.g. allowing for differing species to be seeded onto the terrain) can be provided by varying drop height, amount of slurry and/or slurry consistency.

It is to be understood that, if any prior art is referred to herein, such reference does not constitute an admission that the prior art forms a part of the common general knowledge in the art, in Australia or any other country.

### BRIEF DESCRIPTION OF THE DRAWINGS

One or more embodiments of the present invention will hereinafter be described with reference to the accompanying Figures, in which:

FIG. 1 shows examples of known seeding options, such as manual and machine delivered broadcasting and precision placement.

FIG. 2 shows a chart of probability of emergence for Australian native seeds vs seed depth compared against varying concentrations of rock content.

FIG. 3 shows a chart of cumulative proportion of germinated seeds for each slurry mixture according to embodiments of the present invention relative to a control sample treatment for the combined proportion for plated samples under test.

FIGS. 4A to 4C show various features of an apparatus for depositing a growing medium and seeds according to an embodiment of the present invention.

FIG. 4D shows examples of alternative arrangement of delivery outlets according to various embodiments of the present invention.

FIG. 5 shows a schematic of a system and method for delivery of seeds and growing medium according to an embodiment of the present invention.

FIG. 6 shows examples of growing medium slurry pats deposited on the ground surface.

FIGS. 7A and 7B show examples of seedlings emerging from the deposited pats of the growing medium at one month and six months respectively.

### DESCRIPTION OF PREFERRED EMBODIMENT(S)

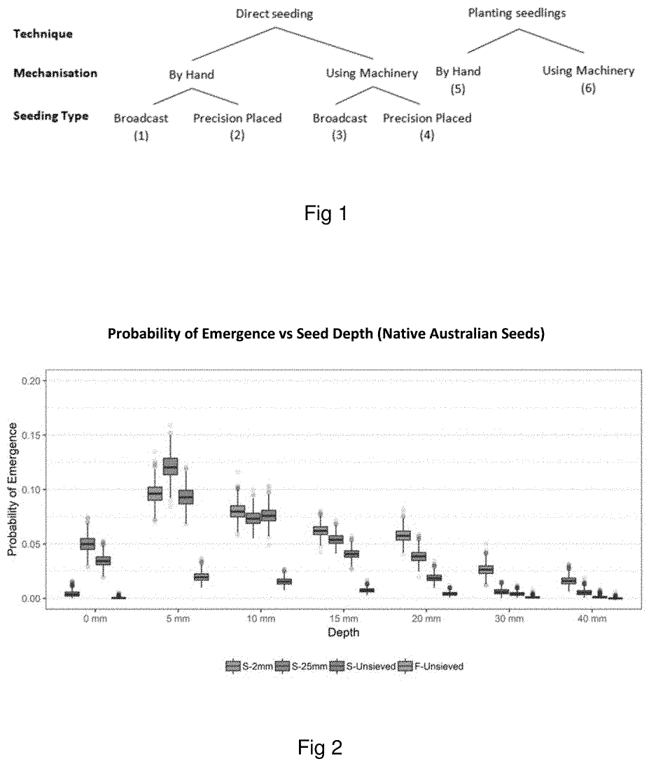

FIG. 1 provides, for background purposes, examples of seeding options, such as manual and machine delivered broadcasting and precision placement.

The chart (Tuley boxplot) of FIG. 2 shows predicted probability of emergence for Australian native seeds (Triodia pungens. T. pungens) vs seed depth at each of 7 experimental depths. The horizontal black band in each box plot represents the median prediction of the probability of emergence for each treatment. The lower and upper hinges represent the first and third quartile, respectively, whilst whiskers represent 1.5 times the interquartile range and outliers are represented by circles, Treatments are represented as seeds/florets-soil type e.g. seeds (S)florets (F) sown in soil sieved to 2 mm, 25 mm or left unsieved.

At shallow burial depths of <15 mm, rock content of the soil did not significantly affect emergence. However, strong evidence exists for a trend towards a reduction in emergence with increasing rock content in the soil when burying seeds to greater than or equal to 15 mm. When buried ≥15 mm, the probability that T. pungens seeds in soil sieved to 2 mm exhibit greater emergence than seeds in soil sieved to 25 mm, which also exhibit greater emergence than seeds in unsieved soil, is 0.87. This probability increases with increasing burial depth and the trend is not present when buried shallower than 15 mm. For 25 mm sieved and unsieved soils, burial to 30 mm or deeper yielded a predicted emergence probability of near zero (<0.006). In soil sieved to 2 mm, however, the predicted emergence was 0.026 and 0.016 when buried to 30 mm and 40 mm respectively, indicating that the, presence of rocks truncated the maximum emergence depth (FIG. 2).

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

Triodia pungens seedling emergence in a test slurry mixture was comparable (10%) to the best performing burial depth in topsoil for Triodia pungens emergence (13%, 5 mm). Achieving a seedling emergence approaching that of seeds placed at the optimal burial depth shows that the concept of the pats is valid and viable.

The seed embryo is a critical organ for germination. Embryos of Triodia seeds, for example, are delicate and can be damaged/removed if knocked during any abrasive seed cleaning processes.

One or more examples of embodiments of the present invention will hereinafter be described.

A test arrangement was established for proving the efficacy of using one or more embodiments of the present invention. As a step to validating one or more embodiments of the present invention, seed germination testing was undertaken to deduce that delivery/deposition of seeds within a growing medium slurry reduce or avoid mechanical damage to the seed, and particularly the embryo.

By way of example, a vehicle (trailer) mounted apparatus extruded slurry pats of two mixtures:
50% waste and 50% topsoil blend (1 part waste; 1 part topsoil; 1 part water); and
100% topsoil (2 parts topsoil; 1 part water)

The aforementioned two mixtures were sieved to 2 mm before

Ten grams of Triodia pungens seeds cleaned from their encasing floret were added to 5 L of each slurry, The ratio of seeds to slurry mixture was selected to provide greater than 35 seeds per pat on average, representing favourable plant recruitment for restoration given a 13% emergence rate.

Ten pats per slurry mixture were deposited (e.g. by pump fed extrusion) from a delivery outlet and dropped into containers from a height of 450 mm. During the tests, approximately 200 L of the growing medium slurry was extruded per hour or roughly 10,000, 0.02 L pats/hour.

The growing medium containing the seeds were extruded as pats in cool dry conditions and immediately washed through a square meshed sieve stack containing sieve sizes of 1.7, 1.18, 0.85, and 0.355 mm. Seeds collected on the sieve mesh from each pat were assessed for damage under a microscope before being plated in 90 mm Petri dishes on a water agar medium. Three sub samples of 25 Triodia pungens seeds were not extruded and therefore provided a control sample also assessed for any seed damage under a microscope and plated on the water agar medium. All of the Petri dishes were cling wrapped and placed in a temperature-controlled incubator set to 30° C. and with a 12/12 hour light/dark cycle (30 μmol m−2 s−1, 400-700 nm, cool-white fluorescent light).

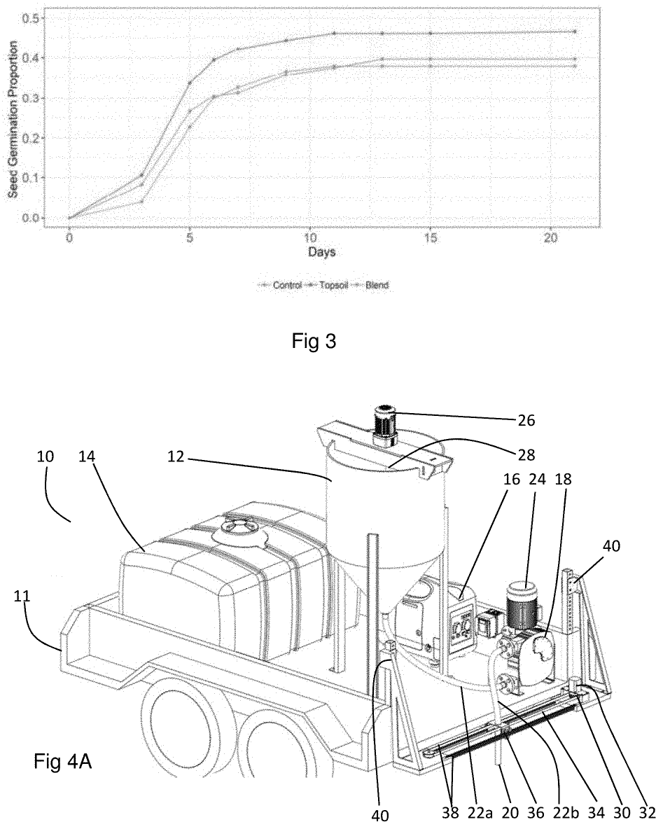

A one way analysis of variance showed no significant difference in the proportion of germinated seedlings in the control or the two slurry mixes, F(2,20)=2.46, p=110, at the 5% confidence level. Mean time to 95% germination for all treatments was between 8 and 11 days (Control 8-9 days, Topsoil only mix 8-9 days, waste-topsoil blended mix 10-11 days) (FIG. 3 showing a chart of cumulative proportion of germinated seeds for each slurry mixture relative to the control sample treatment for the combined proportion for plated samples under test).

Germination results indicate that there is likely no damage to the seeds induced by the extrusion process and that seeds remain germinable after extrusion.

It will be appreciated that embodiments of the present invention enable seed metering and topsoil (with or without additional material, such as waste material) respreading.

Embodiments of the present invention provide for spatial control of seed or growing medium delivery/deposition to a site for (re)establishing plant growth. Placement of pats containing seeds can be anywhere on a 2D surface and can be automated.

Commercial and industrial earth moving vehicles, such as bulldozers are a typical means for carrying air seeding equipment. Air seeding equipment uses a flow of air to deliver seeds from one or more hoppers to prepared ground across mine site areas to be rehabilitated or restored. Tracked vehicles are preferred for working on steep slopes common to mine site restoration. The practice of deep ripping (to >400 mm) conflicts with the requirement for seeds to be buried shallow (<15 mm) in the soil surface in certain geographical locations (e.g. for climate and/or or soil types). Locating seed precisely between 5 to 10 mm in a soil surface with mounds and troughs, sometimes up to 1000 mm high and spaced 1000 mm apart, is an extremely difficult task. There is a perceived requirement by mine operators that a saw tooth structure should be present on restoration sites for benefits to slope stability via reduced erosion or increased plant establishment and health via water harvesting.

However, avoiding deep ripping avoids the need for expensive machinery and associated running costs and personnel time, and alleviates soil compaction by large, heavy vehicles travelling over the soil surface. Being able to deposit seeds directly onto the soil surface using one or more embodiments of the present invention can reduce overall restoration or re-vegetation costs.

Seeding is typically carried out before expected rainfall to improve the chance of seeds germinating. In practice, rainfall events can be unpredictable in particular geographic regions, such as Australia's North West/Pilbara. If seeding does not coincide with an adequate rainfall event, no matter the depth or soil rock content that an un-dormant seed is buried into, low germination or mortality of germinated seedlings will likely result. For this reason, it widely accepted that planting should preferably be finished before seasonal rains to ensure seeds can take advantage of any subsequent major rainfall events. However, watering of the deposited slurry containing the seeds can be carried out prior to rainfall to assist germination. For example, a water reservoir or container may be carried by the vehicle, or an additional supply of water (such as from a water bowser/cart) may be provided for watering the deposited slurry or pellets containing the seeds.

Embodiments of the present invention allow such seeding to be earlier than simple seed blowing/air-seeding given the encapsulation of the seeds within the growing medium, such as in a slurry or in pellets, prevents loss of seeds from the targeted seeding area.

By way of example, Triodia recruits optimally between 5-10 mm depth and that it is likely most species recruit optimally when sown to shallow depths, to maximise emergence from the seedbank and reduce waste of limited topsoil, spreading topsoil or topsoil mixtures to no more, than 10 mm can be advisable. Topsoil can be, replaced to around 200 mm in some regional areas, such as the Pilbara. Reducing the topsoil respreading depth to 10 mm could increase the area which can be treated with topsoil by 20 times.

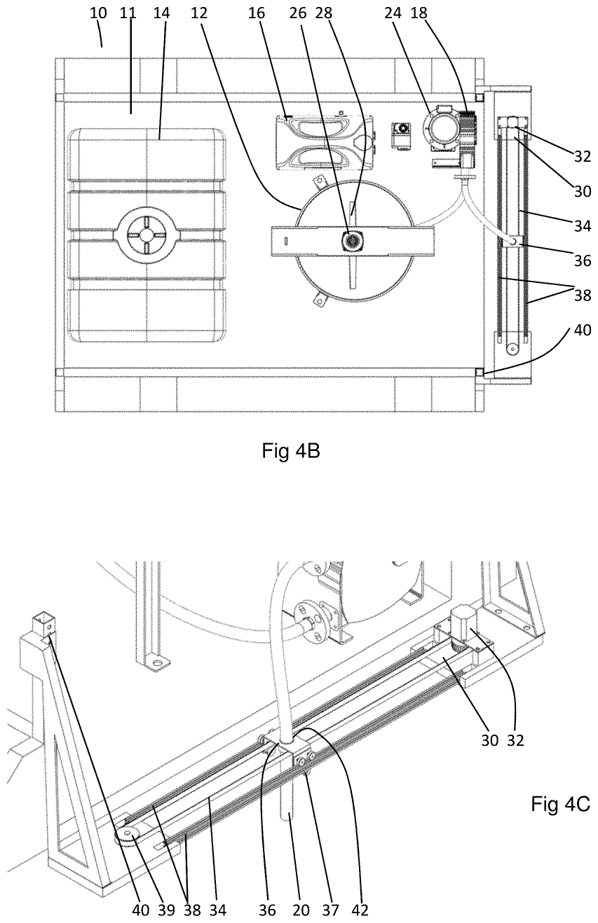

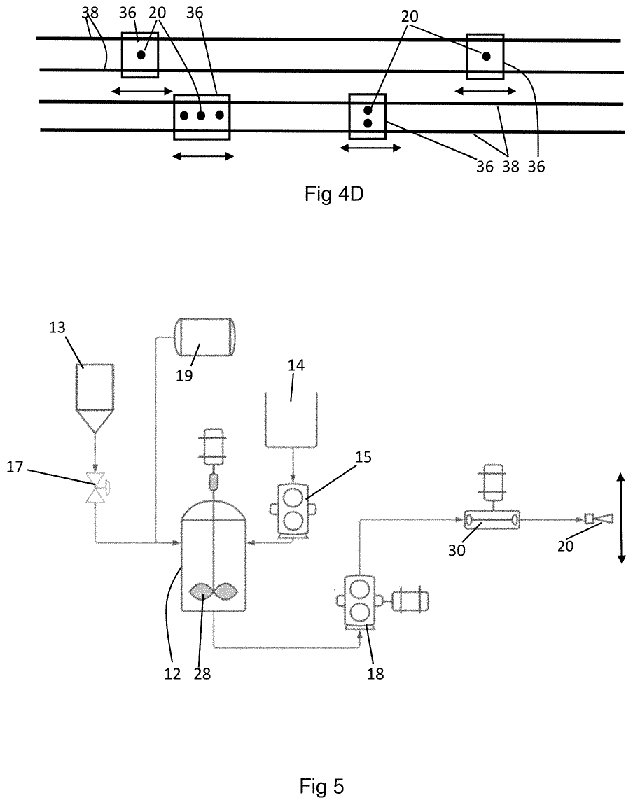

FIGS. 4A to 4C show features of an embodiment exemplifying the present invention.

Apparatus 10 includes a hopper 12 within which are mixed a growing medium (such as soil and/or other organic material), water and seeds. The water can be supplied from a reservoir 14 (such as a container), which can be supplied from the reservoir via a pump 15.

In this embodiment, a generator 16 provides power to a motor 24 to drive a pump 18 and to a motor 26 to power an agitator/mixer 28 for creating and maintaining a slurry within the hopper.

The pump can be a peristaltic pump that produces portions of slurry of volume and periodicity dependent upon the speed of the pump and the number of peristaltic pumping actions per revolution. For example, the pump may have a two-lobed cam producing two pulses of slurry per revolution. Alternatively, a three-lobed cam could produce three pulses per revolution with, each pulse having a volume ⅔rds of the volume of each of the two pulses for the two, lobed cam.

It will be appreciated that other pumping and slurry volume and periodicity controls may be utilised. For example, a valve may be opened and closed periodically to start-stop-start pulses of the slurry.

Slurry is pumped from the hopper 12 via hose 22a through the pump 18 to at least one outlet 20 via hose 22b for depositing the slurry containing the seeds onto the ground surface.

Preferably the apparatus is vehicle 11 mounted, such as on a trailer or dedicated powered vehicle, which may be autonomous, remotely controlled or manned.

The at least one outlet 20 may be configured to move laterally/transversely to vary lateral/transverse position for depositing the slurry onto the ground surface. A position mechanism 30 can include a motor 32 driving an endless belt 34 around a pulley 39. The endless belt is connected to a carriage 36 arranged to slide on rails 38. Height of the at least one outlet can be adjusted, such as by adjusters 40. The respective carriage can be supported and/or retained on the rails by one or more wheels 37. FIG. 4D provides examples of arrangements the delivery outlets 20, allowing for series and/or parallel configurations of the outlets, and optionally multiple outlets in various combinations/positions.

Multiple carriages 36 may be provided, each supporting at least one said outlet 20. For example, alternative arrangements of the position mechanisms may be provided such that multiple carriages do not need to traverse the entire length of the slide rails or carriages can be provided in parallel such that carriages can pass one another along their own respective rails.

Preferably the outlet hose 22b is connected to the carriage 36 via a bearing arrangement 42 that allows a rotational degree of freedom of the hose to reduce or prevent twisting of the hose when traversing along the rails.

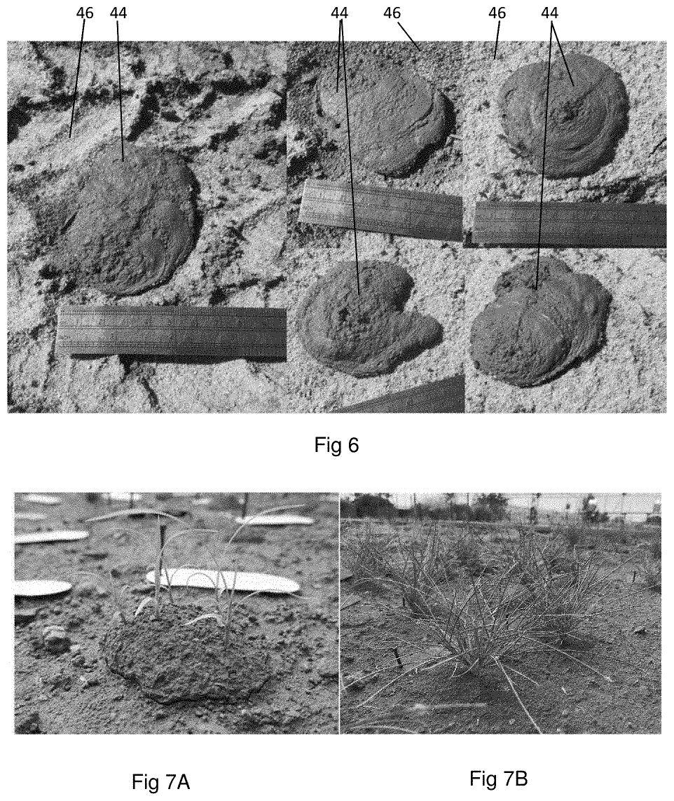

FIG. 6 shows examples of pats 44 of the slurry containing seeds. deposited on the ground surface 46.

FIGS. 7A and 7B show examples of germinated seeds merging as seedlings from the pats.

A method of depositing a growing medium and seeds includes mixing seeds in a growing medium, such as a soil or part soil part other organic material, with water to form a slurry containing the seeds. Alternatively, the slurry can be formed and the seeds blended into the slurry before depositing or added to the deposited slurry.

Portions of the slurry can be deposited at spaced intervals. The intervals can be determined by one or more or speed of traverse over terrain (such as a vehicle speed), rate of depositing (such as by pump and/or valve control), rate of transverse movement of an outlet for delivering the slurry, and height of the respective outlet above a ground surface. Viscosity/density of the slurry may also determine spacing and/or volume of the slurry delivered. Height of the outlet from the ground surface and slurry viscosity/density can be controlled and used to determine volume of slurry to deliver and size (diameter and thickness) of the delivered pat.

It will be appreciated that the apparatus can deposit one or more seeds onto the ground surface and subsequently cover the seeds with the slurry.

Position of the apparatus 10 can be tracked by GPS and the area ted be seeded can be pre-mapped so that the vehicle follows a predetermined seeding pattern. Location of each pat can be recorded e.g. as each pat is delivered to the ground a GPS location is associated with each pat or number of pats in an area. The vehicle may include on-board GDPS and mapping devices.

Embodiments include an arrangement of apparatus and method of use, as shown by way of example in FIG. 5 In FIG. 5, a hopper 12 receives seeds from a seed store 13 via a metering system 17 for controlling rate/volume flow of the seeds.

A growing medium is supplied to the hopper 12 from a container 19.

A water pump 15 supplies water (which may include one or more nutrients for aiding plant growth) from a reservoir 14 to the hopper 12. Supply of water to the hopper can be controlled to manage the consistency of the slurry, such as increasing the amount of water in the hopper for a given amount of growth medium to make the slurry more liquid, which may be preferable in high ambient temperature conditions. An agitator or mixer 28 mixes the water and growth medium into a slurry in which the seeds are dispersed.

A pump arrangement 18 supplies the slurry containing the seeds to at least one outlet 20. Position of the at least one outlet can be controlled by a position mechanism 30, which can traverse the at least one outlet laterally for lateral position and dispensing of the slurry and seeds. Height of the at least one outlet can also be controlled, such as by a mechanical height adjustment arrangement 40 or an electrically, hydraulically or pneumatically powered height control arrangement.

It will be appreciated that embodiments of the present invention can be readily integrated into known restoration or agricultural practices.

Embodiments include an apparatus for use in establishing or re-establishing plant growth over a land area, the apparatus including a supply of a growing medium and an arrangement including at least one delivery outlet for delivering the growing medium at spaced intervals from a height onto a soil surface of the land area, the growing medium contains seeds or is delivered in tandem with and on top of seeds deposited on the soil surface or deposited onto or adjacent to seeds or seedlings already deposited on the soil surface.

Seeds may be contained in the growing medium prior to delivery of the growing medium onto the soil surface.

The apparatus may be configured to deposit the growing medium onto seeds on the soil surface. The apparatus may be arranged to deliver the seeds onto the soil surface and subsequently to deliver the growing medium onto the seeds.

The growing medium may include at least one of a slurry, pellets, granules or a powder. The growing medium may include a slurry including soil and water. The growing medium may include at least one of: a proportion of waste material, one or more nutrients, elements, beneficial compounds, beneficial microbes, soil microbes, anti-stress agents, inorganic compounds and/or organic compounds, soil microbiata. The waste material may include a proportion of a mineral waste from commercial or industrial processes. The mineral waste may include material from one or more of ore/mineral crushing, milling and screening. The growing medium may include soil amendment and/or germination/emergence enhancing products.

Embodiments may include a mixer and/or an agitator for creating the slurry and/or maintaining the growing medium as the slurry in a reservoir.

Embodiments may include at least one delivery device for delivering the growing medium to the at least one delivery outlet via at least one conduit.

Embodiments may include one or more of, or a combination of any two or more of, at least one pump, at least one hopper having at least one respective outlet, at least one gravity feed arrangement, at least one auger, at least one conveyor, at least one vibration screen or chute. The at least one delivery outlet is provided at a desired position above the soil surface.

Embodiments may include at least one position adjuster for adjusting height of the at least one delivery outlet from the ground surface. Height of the at least one delivery outlet from the ground surface may be selected based on one or more of plant species, seed type, travel velocity/speed, speed/velocity of a position mechanism, one or more growing medium properties, viscosity of the growing medium, one or more site soil properties, ambient air temperature and/or ambient humidity, prevailing or predicted weather conditions.

Embodiments include a traverser enables lateral motion of the at least one delivery outlet relative to a forward direction of travel of the at least one delivery outlet. The traverser may include a mechanism aligned perpendicular to the direction of travel which allows pats of the growing medium to be deposited anywhere within lateral width limits. The traverser may include a slider mechanism having at least one carriage for moving/positioning the respective at east one outlet associated with the respective carriage.

Embodiments of the apparatus include a pivot or rotation device, such as a bearing, allowing rotational motion of the respective at least one outlet and/or a conduit in fluid communication with the respective at least one outlet. The pivot or rotation device may enable decoupling of axial twist of a hose in fluid communication relative, to the respective at least one delivery outlet. The at least one traverser may be driven via at least one drive means. Motion of the traverser may be provided by at least one electric motor or at least one hydraulic motor or driven by the driving/trailing wheels of a vehicle conveying at least part of the apparatus.

At least one position of the at least one delivery outlet may be limited by at least one limiting device, such as electronic limit switches. The at least one delivery outlet may include multiple said delivery outlets spaced with respect to one another. The multiple delivery outlets include at least two spaced and/or separately moveable said delivery outlets. The multiple delivery outlets may include coaxial or axially offset with respect to one another. At least one the delivery outlet of the multiple delivery outlets may be arranged and/or configured to move relative to at least one other of the multiple delivery outlets. Two or more said delivery outlets are arranged to move in concert with one another.

Outlet direction for dispensing the growing medium may be controllable. Position of the at least one delivery outlet may be optimised via position/location sensing algorithms, using for example, computer vision, artificial intelligence and/or GPS or predetermined position mapping.

Embodiments may include a metering arrangement for metering delivery/deposition rate and/or volume of the growing medium. Deposition rate may be achieved for example via variable pump speed controlled by a stepper or servo motor. Embodiments of the metering arrangement may include a metering device for metering density of the seeds within the growing medium or independently deposited on the soil surface Embodiments of the apparatus may be mounted to a vehicle or may be self-propelled or may be provided on or as a trailer for towing. Embodiments include a water supply to provide water to adjust consistency of the growing medium. Embodiments include at least one of: a slurry pump, a water pump, a mixer and/or an agitator is powered by an on-board or external power supply. An external power supply for/of the apparatus may come from a power take off (PTO) or electric drive or hydraulic fluid flow or powered off driven/trailing wheel/track.

Embodiments include a method for use in seeding for establishing or re-establishing plant growth over a land area, the method including supplying a growing medium to at least one outlet of a delivery apparatus, depositing at least a portion of the growing medium and seeds onto a soil surface or depositing the growing medium onto the seeds on the soil surface.

Embodiments may include depositing the growing medium containing the seeds or in tandem with dispensing the seeds onto the soil surface. Embodiments may include depositing the seeds onto the soil surface and subsequently depositing the growing medium onto the seeds. Embodiments may include premixing the growing medium as a slurry before dispensing or mixing as a slurry whilst dispensing. The growing medium may include one or more of: topsoil, other organic or inorganic medium, waste material and water. The slurry may include a proportion of at least one waste material. The at least one waste material may include a proportion of a mineral waste from commercial or industrial processes. The mineral waste may include material from one or more of ore or mineral crushing, milling and screening.

Embodiments may include delivering the growing medium to the at least one outlet by at least one delivery device. The at least one delivery device may include one or more of, or a combination of any two or more of, at least one pump, at least one hopper having at least one respective outlet, at least one gravity feed arrangement, at least one auger, at least one conveyor, at least one vibration screen or chute. Embodiments may include delivering the growing medium by pumping the growing medium by use of at least one pump to the at least one delivery outlet via at least one conduit. Embodiments may include providing the at least one delivery outlet at a preferred height above the soil surface. Embodiments may include selecting or controlling the height of the at least one delivery outlet from the ground surface based on one or more of plant species and seed type, travel velocity/speed, speed/velocity of a position mechanism, one or more growing medium properties, viscosity of the growing medium, one or more site soil properties, ambient air temperature and/or ambient humidity, prevailing or predicted weather conditions. Embodiments may include using a position mechanism to control lateral position of the at least one delivery outlet. Embodiments may include controlling lateral motion of the at least one delivery outlet relative to a forward direction of travel of the at least one delivery outlet. Embodiments may include metering delivery/deposition rate and/or volume of the growing medium and the seeds. Embodiments may include metering density of, the seeds within the growing medium. Embodiments may include depositing the growing medium to form at least one pat on contact or after contact with the soil surface. When the at least one delivery outlet is moving, delivery of the growing medium may be intermittent such that, said pats are created spaced on the surface of the soil. Delivery of the growing medium may be controlled in association with one to six degrees of freedom of motion of the at least one delivery outlet. Delivery of the growing medium onto the surface of the soil may be synchronised to forward and/or lateral motion of the at least one delivery outlet. Position of the at least one delivery outlet may be controlled by a position mechanism that moves the at least one delivery outlet.

The position mechanism may include a traverser enabling lateral motion of the at least one delivery outlet relative to a forward direction of travel of the at least one delivery outlet. The traverser may move the at least one delivery outlet by a slider mechanism aligned perpendicular to the direction of travel which allows the growing medium to be deposited anywhere within lateral width limits of the traverser. Use of the traverser may include the slider mechanism allowing motion of a slider in either direction along a longitudinal extent of a slide bar Embodiments may include providing the growing medium including microbes beneficial to the seeds/plants.

Delivered/deposited growing medium may be as slurry pats between 5 mm and 12 mm thick on average, preferably between 6 mm and 10 mm thick on average, and more preferably between 7.5 mm and 9 mm thick on average.

Embodiments may include depositing the growing medium from a vehicle in motion. Depositing of the growing medium containing the seeds may include being guided and/or controlled via external communication or predetermined guidance program.

Embodiments may include mixing and/or agitating at least part of the growing medium as a slurry in a storage container prior to depositing. Embodiments may include adjusting consistency of the growing medium prior to delivery/depositing.

Embodiments may include controlling vertical position of the at, least one delivery outlet for delivering the growing medium as a slurry by height control means to control morphology of the resulting slurry deposition. Embodiments may include limiting at least one position of the at least one delivery outlet by at least one limiting device, such as electronic limit switches. Embodiments may include providing multiple said delivery outlets spaced laterally with respect to one another. Embodiments may include the growing medium incorporating soil amendment and germination/emergence enhancing products.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus for use in establishing or re-establishing plant growth over a land area, the apparatus comprising:
a supply of a growing medium and an arrangement comprising a delivery outlet for delivering the growing medium at spaced intervals from a height onto a soil surface of a land area, the growing medium comprising seeds or is delivered in tandem with and on top of seeds deposited on the soil surface or deposited onto or adjacent to seeds or seedlings already deposited on the soil surface.

2. The apparatus of claim 1, wherein the seeds are contained in the growing medium prior to delivery of the growing medium onto the soil surface.

3. The apparatus of claim 1, wherein the apparatus:
is configured to deposit the growing medium onto seeds on the soil surface; or
is arranged to deliver the seeds onto the soil surface and subsequently to deliver the growing medium onto the seeds.

4. The apparatus of claim 1, wherein the growing medium comprises one or more of:
a slurry;
pellets;
granules;
a powder; and
soil amendment, and/or germination/emergence enhancing products.

5. The apparatus of claim 4, wherein the growing medium comprises the slurry and the apparatus further comprising a mixer and/or an agitator for creating the slurry and/or maintaining the growing medium as the slurry in a reservoir.

6. The apparatus of claim 1, wherein:
the growing medium comprises at least one of:
a proportion of waste material,
one or more nutrients,
elements,
beneficial compounds,
beneficial microbes,
soil microbes,
anti-stress agents,
inorganic compounds,
organic compounds, and
soil microbtota;
wherein the waste material comprises a proportion of a mineral caste from commercial or industrial processes; and
the mineral waste comprises material from one or more of ore/mineral crushing, milling, and screening.

7. The apparatus of claim 1, comprising a delivery device for delivering growing medium to the delivery outlet via a conduit;
wherein the delivery device comprises one or more of, or a combination of any two or more of:
a pump,
a hopper comprising a respective outlet,
a gravity feed arrangement,
an auger,
a conveyor,
a vibration screen, or
a chute.

8. The apparatus of claim wherein:
the delivery outlet is provided at a desired position above the soil surface;
the apparatus further comprises a position adjuster for adjusting a height of the delivery outlet from the soil surface;
the height of the delivery outlet from the soil surface is selected based on one or more of:
plant species,
seed type,
travel velocity/speed,
speed/velocity of a position mechanism,
one or more growing medium properties,
viscosity of the growing medium,
one or more site soil and/or landform properties,
ambient air temperature and/or ambient humidity,
prevailing or predicted weather conditions;
a traverser enabling lateral motion of the delivery outlet relative to a forward direction of travel of the delivery outlet;
the traverser comprising a mechanism aligned perpendicular to the direction of travel which allows pats of the growing medium to be deposited anywhere within lateral width limits;
the traverser comprising a slider mechanism comprising a carriage for moving/positioning the delivery outlet;
the traverser is driven via a drive means; and
at least one position of the delivery outlet is limited by a limiting device.

9. The apparatus of claim 1, comprising a pivot or rotation device allowing rotational motion of the delivery outlet and/or a conduit in fluid communication with the delivery outlet;
wherein the pivot or rotation device enables decoupling of axial twist of a hose in fluid communication relative to the delivery outlet; and
the motion of a traverser is provided by an electric motor or a hydraulic motor or driven by driving/trailing wheels of a vehicle conveying at least part of the apparatus.

10. The apparatus of claim 1, further comprising a second delivery outlet, wherein:
the delivery outlet and the second delivery outlet e spaced with respect to one another,
an outlet direction for dispensing the growing medium is controllable;
the delivery outlet and the second, delivery outlet are coaxial or axially offset with respect to one another; and
the delivery outlet is arranged to move relative to the second delivery outlet, or the delivery outlet and the second delivery outlet are arranged to move in concert with one another.

11. The apparatus of claim 1, wherein the position of the delivery outlet optimized via position/location sensing algorithms.

12. The apparatus of claim 1, comprising:
a metering arrangement for metering delivery/deposition rate and/or volume of the growing medium; and
a water supply to provide water to adjust consistency of the growing medium.

13. The apparatus of claim 12, wherein:
the deposition rate is achieved via a variable pump speed controlled by a stepper or servo motor; and
the metering arrangement comprises a metering device for metering density of the seeds within the growing medium or independently deposited on the soil surface.

14. The apparatus of claim 1, wherein the apparatus is configured to be mounted to a vehicle, is self-propelled, or is configured to be provided on or as a trailer for towing.

15. The apparatus of claim 1, wherein at least one of: a slurry pump, a water pump, a mixer, and/or an agitator is powered by an on-board or external power supply, the external power supply coming from a power take off (PTO) or electric drive or hydraulic fluid flow or powered off driven/trailing wheel/track.

16. A method for use in seeding for establishing or re-establishing plant growth over a land area, the method comprising:
supplying a growing medium to an outlet of a delivery apparatus,
depositing at least a portion of the growing medium and seeds onto a soil surface or depositing the growing medium onto the seeds on the soil surface.

17. The method of claim 16, wherein the growing medium comprises one or more of: topsoil, other organic or inorganic medium, waste material, and water.

18. The method of claim 16, comprising one or more of:
depositing the growing medium containing the seeds or in tandem with dispensing the seeds onto the soil surface;
depositing the seeds onto the soil surface and subsequently depositing the growing medium onto the seeds;
premixing the growing medium as a slurry before dispensing, or mixing as a slurry while dispensing;
delivering the growing medium to the outlet of the delivery device;
providing the outlet at a preferred height above the soil surface;
using a position mechanism to control lateral position of the outlet;
metering delivery/deposition rate and/or volume of the growing medium and the seeds;
metering density of the seeds within the growing medium;
depositing the growing medium to form a pat on contact or after contact with the soil surface;
providing the growing medium comprising microbes beneficial to seeds/plants;
depositing the growing medium from a vehicle in motion;
mixing and/or agitating at least part of the growing medium as a slurry in a storage container prior to depositing;
adjusting consistency of the growing medium prior to delivery/depositing;
controlling a vertical position of the outlet for delivering the growing medium as a slurry by height control means to control morphology of the resulting slurry deposition and optimize slurry-soil contact;
limiting a position of the outlet by a limiting device;
providing a second outlet spaced laterally with respect to the outlet; and
providing the growing medium with soil amendment and germination/emergence enhancing products.

19. The method of claim 18, wherein:
the slurry comprises a proportion of a waste material the waste material comprising one or more of:
mineral waste from commercial or industrial processes; and
material from one or more of ore or mineral crushing, milling and screening; and
the delivery device one or more of or a combination of any two or more of:
a pump,
a hopper comprising the outlet,
a gravity feed arrangement,
an auger,
a conveyor,
a vibration screen, or
a chute.

20. The method of claim 18, comprising delivering the growing medium by pumping the growing medium by use of a pump to the outlet via a conduit.

21. The method of claim 18, comprising:
selecting or controlling a height of the outlet from the soil surface based on one or more of: plant species and seed type, travel velocity/speed, speed/velocity of the position mechanism, one or more growing medium properties, viscosity of the growing medium, one or more site soil and/or landform properties, ambient air temperature and/or ambient humidity prevailing or predicted weather conditions; and
controlling lateral motion of the outlet relative to a forward direction of travel of the outlet.

22. The method of claim 18, wherein:
when the outlet is moving, delivery of the growing medium is intermittent such that the pat is created spaced from a second pat on the soil surface;
delivery of the growing medium is controlled in association with one to six degrees of freedom of motion of the outlet;
a position of the outlet is controlled by the position mechanism that moves the outlet;
the position mechanism comprises a traverser enabling lateral notion of the outlet relative to a forward direction of travel of the outlet;
the traverser moves the outlet by a slider mechanism aligned perpendicular to the forward direction of travel which allows the growing medium to be deposited anywhere within lateral width limits of the traverser;
the traverser comprises the slider mechanism allowing motion of a slider in either direction along a longitudinal extent of a slide bar; and
depositing the growing medium containing the seeds is guided and/or controlled via external communication or predetermined guidance program.

23. The method of claim 16, wherein delivery of the growing medium onto the soil surface is synchronized to forward and/or lateral motion of the outlet.

24. The method of claim 16, wherein delivered/deposited the growing medium as slurry pats are between 5 mm and 12 mm thick on average.
